(19) United States
(12) Patent Application Publication
(10) Pub. No.: US 2001/0003522 A1
(43) Pub. Date: Jun. 14, 2001

(54) ISDN rerouting device and ISDN rerouting method

(75) Inventor: Mao Masuhiro, Tokyo (JP)

Correspondence Address: OSTROLENK FABER GERB & SOFFEN, 1180 AVENUE OF THE AMERICAS, NEW YORK, NY, 100368403

(73) Assignee: NEC Corporation

(21) Appl. No.: 09/725,986

(22) Filed: Nov. 29, 2000

(30) Foreign Application Priority Data
Nov. 29, 1999 (JP) 337183/1999

(51) Int. Cl. H04L 12/26; G08C 15/00

(52) U.S. Cl. 370/237; 370/352

(57) ABSTRACT

According to the ISDN rerouting device and the ISDN rerouting method of this invention, CPU 205 establishes a communication call between telephone terminal 30 and telephone terminal 31 via ISDN based on information in memory 206 when the occurrence of congestion in IP network 10 is detected by IP-TRK 202, thereby suppressing packet loss and delays in voice signals during transmission and preventing deterioration or communication quality between telephone terminals.

### BACKGROUND OF THE INVENTION

1. Field of the Invention

The present invention relates to an ISDN rerouting device and ISDN rerouting method for rerouting to an ISDN (Integrated Services Digital Network) when congestion occurs on an IP (Internet Protocol) network.

2. Description of the Related Art

Communication using IP networks has come into wide use in recent years. The IP used in such networks refers to the IP of TCP (Transmission Control Protocol)/IP used on the Internet, and corresponds to the network layer of OSI (Open System Interconnection). The content of this IP regulates communication between Gateways or between a Gateway and a Host on the Internet.

A conventional IP-based PBX system, however, does not typically establish an alternate route even in the event of trouble such as congestion on an IP network. As a result, there is the problem in an IP-based PBX system that the occurrence of congestion on the IP network that exists as the backbone network results in packet loss or delays in speech signals during transmission, and communication quality between telephone terminals thus deteriorates.

### SUMMARY OF THE INVENTION

The present invention was achieved in view of this situation and provides an ISDN rerouting device and ISDN rerouting method that can prevent deterioration in communication quality between telephone terminals.

The ISDN rerouting device of the present invention is provided with a first and a second IP-based PBX system that are connected to a first or second telephone terminal, respectively, by way of telephone lines, and further, connected to each other by way of an IP network and ISDN; wherein the first and second IP-based PBX systems establish a communication call between the first telephone terminal and the second telephone terminal by way of ISDN when congestion occurs on the IP network.

In addition, the first and second IP-based PBX systems are each provided with: an LC (line circuit) for linking with the first or second telephone terminal; a TDSW (time division switch) for switching connection paths; an IP-TRK (trunk circuit) that both interfaces with the IP network and detects the occurrence of congestion on the IP network; an ISDN I/F for interfacing with ISDN; and a CPU for effecting switching control over the TDSW (time division switch) when the IP-TRK (trunk circuit) detects the occurrence of congestion on the IP network.

The CPU further establishes communication calls between the first telephone terminal and second telephone terminal based on information stored in memory.

The memory stores a mapping table having IP addresses and ISDN addresses and an rerouting information table having originating telephone numbers(calling party numbers), destination telephone numbers(called party numbers), IP addresses of destination IP-TRK, and ISDN addresses that correspond to IP addresses of destination IP-TRK.

The ISDN rerouting method of the present invention reroutes to ISDN when congestion occurs on an IP network, is provided with a first and a second IP-based PBX system that are connected to a first or second telephone terminal, respectively, by way of telephone lines, and further, connected to each other by way of the IP network and ISDN; and is provided with a first step in which the first and second IP-based PBX systems establish a communication call between the first telephone terminal and second telephone terminal by way of ISDN when congestion occurs on the IP network.

The first step further includes: a second step of linking with the first or second telephone terminal by means of an LC (line circuit); a third step of switching the connection path by means of a TDSW (time division switch); a fourth step of interfacing with the IP network and detecting the occurrence of congestion on the IP network by means of an IP-TRK (trunk circuit); a fifth step of interfacing with the ISDN by means of an ISDN I/F; and a sixth step of effecting switching control of TDSW (time division switch) by means of a CPU when the IP-TRK (trunk circuit) detects the occurrence of congestion on the IP network.

The sixth step further includes a seventh step of establishing a call between the first telephone terminal and the second telephone terminal based on information stored in memory.

The seventh step further includes an eighth step of storing in memory: a mapping table having IP addresses and ISDN addresses; and a rerouting information table having originating telephone numbers(calling party numbers), destination telephone numbers(called party numbers), IP addresses of destination IP-TRK, and ISDN addresses corresponding to the IP addresses of destination IP-TRK.

In the ISDN rerouting device and ISDN rerouting method according to the present invention, the ISDN rerouting device establishes a call between a first telephone terminal and a second telephone terminal via ISDN by means of first and second IP-based PBX systems when congestion occurs on the IP network, thereby preventing delays in voice signals or packet loss that occur during transmission via the IP network.

As described in the foregoing explanation, according to the ISDN rerouting device and ISDN rerouting method, using the first and second IP-based PBX systems to establish a call between a first telephone terminal and second telephone terminal via ISDN and transmitting voice signals via ISDN when congestion occurs on the IP network can prevent delays in voice signals and packet loss that occur when transmitting via the IP network, thereby preventing deterioration in communication quality between telephone terminals.

The above and other objects, features, and advantages of the present invention will become apparent from the following description based on the accompanying drawings which illustrate examples of preferred embodiments of the present invention.

### BRIEF DESCRIPTION OF THE DRAWINGS

FIG. 1 is a block diagram showing the mode of a first embodiment of the ISDN rerouting device of the present invention.

FIG. 2 is a block diagram showing the details of an IP-based PBX system of FIG. 1.

FIG. 3 shows a mapping table of the memory of FIG. 2.

FIG. 4 shows a rerouting information table of the memory shown in FIG. 2.

### DETAILED DESCRIPTION OF THE PREFERRED EMBODIMENTS

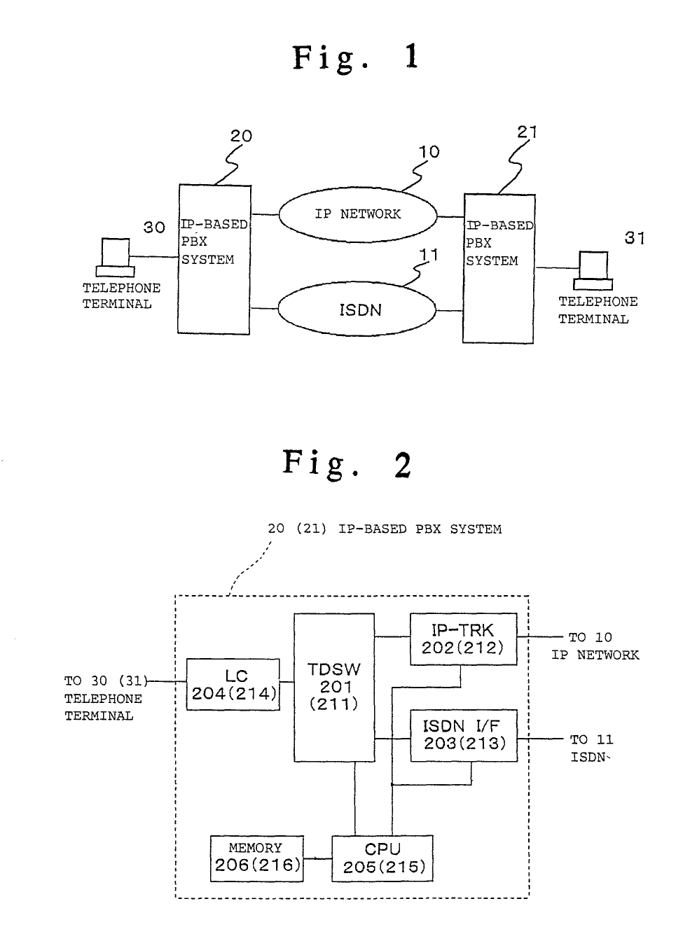

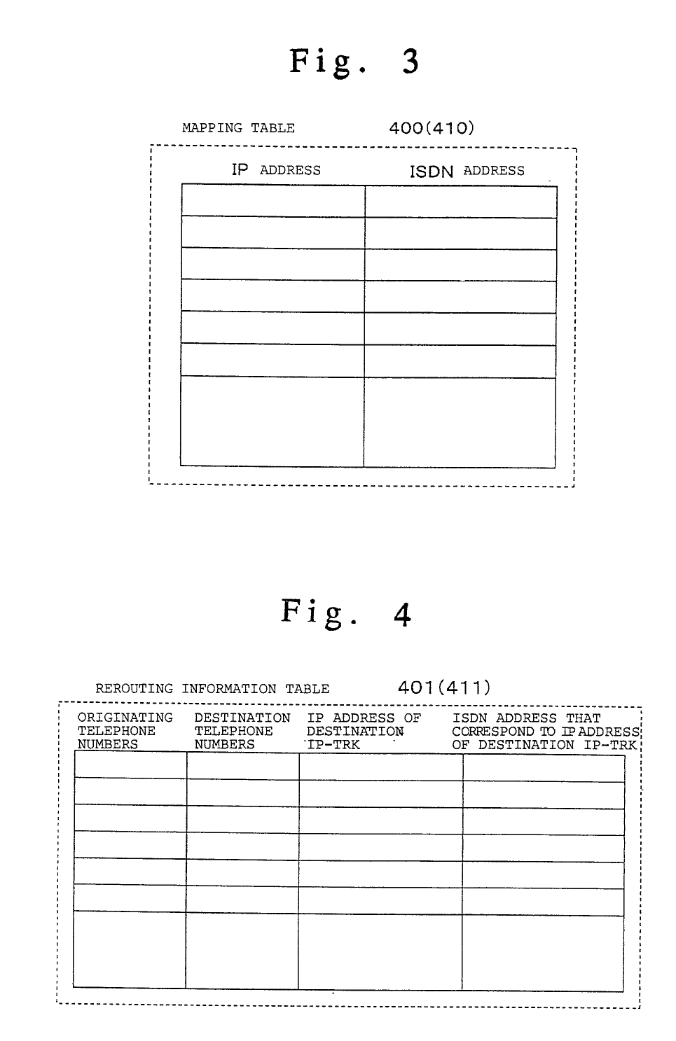

Next, regarding an embodiment of the present invention, we refer to: FIG. 1, which shows a block diagram of a first mode of an embodiment of the ISDN rerouting device of the present invention; FIG. 2, which shows a block diagram of the details of the IP-based PBX system in FIG. 1; and FIG. 3 and FIG. 4, which show a mapping table and rerouting information table, respectively, of the memory in FIG. 2.

The ISDN rerouting device shown in FIG. 1 is provided with IP-based PBX systems 20 and 21 as the first and second IP-based PBX systems.

IP-based PBX systems 20 and 21 are connected by way of IP network 10 and ISDN 11. As the first and second telephone terminals, telephone terminals 30 and 31 are connected by way of telephone lines to IP-based PBX systems 20 and 21, respectively.

Referring now to FIG. 2, in which are shown the details of IP-based PBX systems 20 and 21, IP-based PBX system 20 is provided with: TDSW (time division switch) 201, IP-TRK (trunk circuit) 202, ISDN I/F 203, LC (line circuit) 204, CPU 205, and memory 206.

TDSW 201 establishes calls with IP-TRK 202 or with ISDN I/F 203. IP-TRK 202 converts IP packets that have arrived from IP network 10 to TDM (time division multiplexed) signals, and transmits these TDM signals to TDSW 201. IP-TRK 202 also converts TDM signals that have arrived from TDSW 201 to IP packets and transmits these IP packets to IP network 10. IP-TRK 202 further detects the occurrence of congestion on IP network 10 and notifies CPU 205.

ISDN I/F 203 interfaces with ISDN 11. LC (line circuit) 204 links calls with telephone terminal 30. CPU 205 executes procedures that support call setting of ISDN 11 via ISDN I/F 203. Memory 206 includes mapping table 400 and rerouting information table 401, to be described hereinbelow.

Similar to IP-based PBX system 20, IP-based PBX system 21 is provided with: TDSW (time division switch) 211, IP-TRK (trunk circuit) 212, ISDN I/F 213, LC (line circuit) 214, CPU 215, and memory 216.

Mapping table 400 of memory 206 contains IP addresses and ISDN addresses as shown in FIG. 3.

As shown in FIG. 4, rerouting information table 401 of memory 206 includes: originating telephone numbers(calling party numbers), destination telephone numbers(called party numbers), IP addresses of destination IP-TRK 212, and ISDN addresses that correspond to IP addresses of destination IP-TRK 212.

Memory 216 of IP-based PBX system 21 has mapping table 410 and rerouting information table 411 of the same structure as memory 206 of IP-based PBX system 20.

Next, regarding the operation of the ISDN rerouting device of this configuration, each of IP-based PBX systems 20 and 21 first prepares mapping tables 400 and 410 of the IP addresses and ISDN addresses of IP-TRK 202 and 212, respectively, in memories 206 and 216.

Next, if, for example, telephone terminal 30 originates a call to telephone terminal 31, CPU 205 of IP-based PBX system 20 analyzes the dial signal that is transmitted from telephone terminal 30 and recognizes that the destination is telephone terminal 31 in IP-based PBX system 21.

IP-based PBX system 20 receives the request for connection from telephone terminal 30 to telephone terminal 31, and as a result, IP-TRK 202 converts the voice signals transmitted from TDSW 201 to IP packets in order to connect to IP-based PBX system 21, adds the IP address of IP-TRK 212 of the IP-based PBX system 21 side to the DA (Destination address), and transmits to IP network 10.

CPU 205 then instructs IP-TRK 202 to convert the IP packets, in which the IP address of IP-TRK 212 has been added to the SA (Source Address) that has been transmitted from IP network 10, to voice signals, and to send the signals to TDSW 201.

CPU 205 effects control over TDSW 201 such that LC (line circuit) 204 and IP-TRK 202 are connected.

At IP-based PBX system 21, in order to connect to IP-based PBX system 20, IP-TRK 212 converts voice signals transmitted from TDSW 211 to IP packets, adds the IP address of IP-TRK 202 on the IP-based PBX system 20 side to the DA (Destination Address), and transmits to IP network 10.

CPU 215 then instructs IP-TRK 212 to convert the IP packets transmitted from IP network 10, in which the IP address of IP-TRK 202 has been added to the SA (Source Address), to voice signals and to transmit the packets to TDSW 211.

CPU 215 further effects control over TDSW 211 such that LC (line circuit) 214 and IP-TRK 212 are connected.

At this point, originating IP-based PBX system 20 stores the set telephone numbers of telephone terminal 30 and 31, the IP address of IP-TRK 212 of destination IP-based PBX system 21, and the ISDN address corresponding to the IP address of destination IP-TRK 212 in rerouting information table 401 in memory 206.

In the event of a congested state in IP network 10, the increase in delay of packets causes IP-TRK 202 in IP-based PBX system 20 to detect the state and notify CPU 205. CPU 205 reads the telephone number of telephone terminal 31 and the ISDN address corresponding to the IP address of IP-TRK 212 on the IP-based PBX system 21 side from rerouting information table 401 in memory 206.

CPU 205 also uses the ISDN address of IP-TRK 212 that was read to request a connection to IP-based PBX system 21 via ISDN 11.

IP-based PBX system 21 carries out call connection by returning response information to the request for connection that arrives by way of ISDN 11 from IP-based PBX system 20.

IP-based PBX system 20 then uses the user/user interface of ISDN 11 (contained in the program that is executed by CPU 205) to report the telephone number of telephone terminal 31 to Is-based PBX system 21 and requests the change of the call connection of telephone terminal 31 from IP network 10 to ISDN 11.

IP-based PBX system 20 also effects control over TDSW 201 such that the connection of telephone terminal 30 and IP-TRK 202 is changed to the connection of telephone terminal 30 and ISDN I/F 203.

IP-based PBX system 21 similarly changes the connection between telephone terminal 31 and IP-TRK 212 to a connection between telephone terminal 31 and ISDN I/F 213.

IP-based PBX system 21 then establishes the communication call between telephone terminal 30 that is connected to IP-based PBX system 20 and telephone terminal 31 that is connected to IP-based PBX system 21 via ISDN 11.

In the present embodiment, therefore, CPU 205 establishes a communication call between telephone terminal 30 and telephone terminal 31 via ISDN 11 based on the information of memory 206 when IP-TRK 202 detects congestion that occurs on IP network 10, thereby preventing packet loss and delays in voice signals that occur during transmission via IP network 10 and preventing deterioration in communication quality between telephone terminals.

While a preferred embodiment of the present invention has been described using specific terms, such description is for illustrative purposes only, and it is to be understood that changes and variations may be made without departing from the spirit or scope of the following claims.

What is claimed is:

1. An ISDN rerouting device provided with a first and a second IP-based PBX systems that are connected to a first or a second telephone terminal, respectively, via telephone lines, and further, that are connected to each other via an IP network and ISDN; wherein:
said first and second IP-based PBX systems establish a communication call between said first telephone terminal and said second telephone terminal via said ISDN when congestion occurs in said IP network.

2. An ISDN rerouting device according to claim 1 wherein said first and second IP-based PBX systems are provided with:
an LC (line circuit) for linking with said first or said second telephone terminal;
a TDSW (time division switch) for switching connection paths;
an IP-TRK (trunk circuit) for both interfacing with said IP network and detecting the occurrence of congestion in said IP network;
an ISDN I/F for interfacing with said ISDN; and
a CPU for controlling switching of said TDSW (time division switch) when said IP-TRK (trunk circuit) detects the occurrence of congestion in said IP network.

3. An ISDN rerouting device according to claim 1 wherein said CPU establishes a communication call between said first telephone terminal and said second telephone terminal based on information stored in a memory.

4. An ISDN rerouting device according to claim 2 wherein said CPU establishes a communication call between said first telephone terminal and said second telephone terminal based on information stored in a memory.

5. An ISDN rerouting device according to claim 3 wherein said memory stores:
a mapping table containing IP addresses and ISDN addresses; and
a rerouting information table containing:
originating telephone numbers or calling party numbers, destination telephone numbers or called party numbers, IP addresses of destination IP-TRK, and ISDN addresses that correspond to IP addresses of destination IP-TRK.

6. An ISDN rerouting device according to claim 4 wherein said memory stores:
a mapping table containing Is addresses and ISDN addresses; and
a rerouting information table containing:
originating telephone numbers or calling party numbers, destination telephone numbers or called party numbers, IP addresses of destination IP-TRK, and ISDN addresses that correspond to IP addresses of destination IP-TRK.

7. An ISDN rerouting method that is provided with: first and second IP-based PBX systems that are both connected to a first or a second telephone terminal, respectively, via telephone lines and that are connected to each other via an IP network and ISDN; and that reroutes to said ISDN when congestion occurs in said IP network; comprising:
a first step of establishing, by means of said first and second IP-based PBX systems, a communication call between said first telephone terminal and said second telephone terminal via said ISDN when congestion occurs in said IP network.

8. An ISDN rerouting method according to claim 7 wherein said first step comprises:
a second step of linking with said first or second telephone terminal by means of an LC (line circuit);
a third step of switching the connection path by means of a TDSW (time division switch);
a fourth step of both interfacing with said IP network and detecting the occurrence of congestion in the IP network by means of an IP-TRK (trunk circuit);
a fifth step of interfacing with said ISDN by means of an ISDN I/F; and
a sixth step of effecting switching control of said TDSW (time division switch) by means of a CPU when said IP-TRK (trunk circuit) detects the occurrence of congestion in said IP network.

9. An ISDN rerouting method according to claim 8 wherein said sixth step includes a seventh step of establishing a communication call between said first telephone terminal and said second telephone terminal based on information that is stored in memory.

10. An ISDN rerouting method according to claim 9 wherein said seventh step includes an eighth step of storing in said memory: a mapping table having IP addresses and ISDN addresses; and a rerouting information table having originating telephone numbers or calling party numbers, destination telephone numbers or called party numbers, IP addresses of destination IP-TRK, and ISDN addresses corresponding to IP addresses of destination IP-TRK.
